(19) United States
(12) Patent Application Publication
(10) Pub. No.: US 2015/0267121 A1
(43) Pub. Date: Sep. 24, 2015

(54) FLAME-RETARDANT COATING MATERIAL AND FLAME-RETARDANT SUBSTRATE

(71) Applicant: CHI LIN TECHNOLOGY CO., LTD., Tainan City (TW)

(72) Inventors: Cheng-Dar Liu, Tainan City (TW); Yu-Chi Wang, Tainan City (TW); Chen-Ming Hsu, Tainan City (TW); Buh-Luen Chen, Tainan City (TW); Che-I Kao, Tainan City (TW); Shih-Hao Chou, Tainan City (TW); Sheng-Mao Tseng, New Taipei City (TW); Shu-Lan Yao, New Taipei City (TW)

(21) Appl. No.: 14/437,176

(22) PCT Filed: Nov. 8, 2013
(86) PCT No.: PCT/US2013/069221

§ 371 Date: Apr. 20, 2015

(30) Foreign Application Priority Data
Nov. 8, 2012 (TW) 101141667
Nov. 7, 2013 (TW) 102140543

(51) Int. Cl. C09K 21/14; C09D 175/04; C08K 3/32; D21H 19/24

(52) U.S. Cl. CPC C09K 21/14; D21H 19/24; C09D 175/04; C08K 3/32; C08K 2003/323

(57) ABSTRACT

A flame-retardant coating material and a flame-retardant substrate are provided. The flame-retardant coating material comprises: a polyurethane resin, an isocyanate compound has a plurality of isocyanate (—NCO) groups, and at least one metal hydroxide. The isocyanate groups of the isocyanate compound are linked to the polyurethane resin and the metal hydroxide, respectively. The flame-retardant coating material is halogen-free and can provide flame-retardant property and comply with environmental protection regulations.

### FIELD OF THE INVENTION

The present invention relates to a flame-retardant coating material and a flame-retardant substrate, especially to a non-halogen flame-retardant coating material and a non-halogen flame-retardant substrate.

### BACKGROUND OF THE INVENTION

In order to comply with fire security regulations, industrial or upholstery fabrics need to treat with flame retardant, in which a halogen compound is the main component used in the flame-retardant coating material for current textile fabrics to have flame-retardant property and then matches with some antimony-based flame retardants. The halogen compound, such as polyvinyl chloride (PVC), has excellent flame-retardant effect, and is widely used in surface veneer, wallpaper and other interior decoration purposes. However, the flame retardant coating material containing PVC and halogen are easily decomposed to produce dioxins and other toxic gases when they are heated; in the meantime, because such a flame retardant coating material has halogen and a large number of plasticizers, thus they do not meet EU environmental regulations and the related products cannot be output to Europe and other regions to sell.

Therefore, it is necessary to provide a flame retardant coating material and substrate to solve the problems existing in the conventional technology, as described above.

### SUMMARY OF THE INVENTION

The primary object of the present invention is to provide a flame-retardant coating material and substrate, which comprises a polyurethane resin, a isocyanate compound having a plurality of isocyanate groups and a metal hydroxide to form a non-halogen and flame-retardant coating material, thus not only offer the excellent flame-retardant properties, but also meet environmental regulations of non-toxic coating.

In order to achieve the above object, the present invention provides a flame-retardant coating material, which comprises a polyurethane resin; an isocyanate compound having a plurality of isocyanate (—NCO) groups; and at least one metal hydroxide, wherein the isocyanate groups of the isocyanate compound are linked respectively to the polyurethane resin and the metal hydroxide.

In one embodiment of the present invention, the weight ratio of the polyurethane resin, the isocyanate compound and the metal hydroxide is 50:0.1˜1:20˜80.

In one embodiment of the present invention, further comprises a phosphorus-based flame retardant.

In one embodiment of the present invention, further comprises expandable graphite.

In one embodiment of the present invention, the polyurethane resin has a plurality of hydrophilic groups selected from sulfonyl groups or carboxyl groups.

In one embodiment of the present invention, the isocyanate compound is an oligomer of hexamethylene diisocyanate modified by hydrophilic groups.

In one embodiment of the present invention, the metal hydroxide is magnesium hydroxide or aluminum hydroxide.

In one embodiment of the present invention, the average particle diameter of the metal hydroxide is from 1 to 15 microns (um).

In one embodiment of the present invention, the metal hydroxide is modified by the surface modification and has several amino groups.

In one embodiment of the present invention, the metal hydroxide is modified by a surface modification and has several amino groups (—NH₂).

In one embodiment of the present invention, further comprises a metal powder or a metal mesh.

Furthermore, the present invention provides a flame-retardant substrate, which comprises: a sheet material; and a flame-retardant coating material as mentioned above, which is applied on the sheet material.

In one embodiment of the present invention, the sheet material is selected from a fabric, a paper or a plastic sheet.

In one embodiment of the present invention, the fabric is a cotton-based fabric or a poly(ethylene terephthalate)-based (PET) fabric.

In one embodiment of the present invention, the plastic sheet is a polypropylene sheet

### DETAILED DESCRIPTION OF THE PREFERRED EMBODIMENTS

The abovementioned and other objects, features, advantages of the present invention can be more clearly understood by referring to particular preferred embodiments, as detailed below.

According to a preferred embodiment of the present invention, the present invention provides a flame-retardant coating material which comprises a type of polyurethane resin, a type of isocyanate compound having a number of isocyanate groups (—NCO), and a type of metal hydroxide, wherein the isocyanate groups of the isocyanate compounds are linked respectively to the polyurethane resin and the metal hydroxide, thereby forming the organic-inorganic hybrid polymeric film.

In this embodiment, the weight ratio of the waterborne Polyurethane resin, the isocyanate compounds and the metal hydroxide in solid can be 50:0.1˜1:20˜80, when necessary, a type of phosphorus-based flame retardant can be included, for example, ammonium polyphosphate. At this time, the weight ratio of the waterborne Polyurethane resin, the isocyanate compounds and the metal hydroxide in solid can be 50:0.1˜1:20˜80:5˜40. In addition, a type of expandable graphite also can be contained for the flame-retardant coating being suitable as a veneer, wherein the weight ration of the expandable graphite would be adjusted in accordance with the requirement of the product, which is not limited in the present invention.

In this embodiment, the waterborne Polyurethane resin can be classified into anionic, cationic and non-ionic polyurethane, wherein the anionic polyurethane can be classified into sulfonyl type and carboxyl type, i.e. the waterborne Polyurethane resin may have a plurality of sulfonyl groups (—SO₃H) or a carboxyl groups (—COOH).

Moreover, the isocyanate compound is a crosslinker pre-treated by hydrophilic modification, and has a plurality of isocyanate groups (—NCO). The isocyanate compound, such as the oligomer based on hexamethylene diisocyanate modified by hydrophilic modification, can link to the waterborne Polyurethane resin by the isocyanate group.

In addition, the metal hydroxide is the aluminum hydroxide (Al(OH)₃) or magnesium hydroxide (Mg(OH)₂) which is pre-treated by surface modification and has a predetermined average particle diameter, wherein the predetermined average particle diameter is preferably controlled in the range between 1 and 15 microns (μm). Each of the metal hydroxide particles has a plurality of amino groups (—NH₂) after surface modification, the amino groups are only located on the surface of the particles, in which the particles bind to at least one of the isocyanate groups of the isocyanate compounds via the amino group. When the flame-retardant coating material is heated in burning place, the particles of the metal hydroxide would be heated to release the vapor and turn into the metal oxides to block heat conduction.

In this embodiment, the flame retardant coating material is previously applied on a sheet material to be a flame-retardant substrate, wherein the sheet material is selected from a fabric, a paper or a plastic sheet. The flame retardant coating material, for example, is previously applied on a fabric to be a flame-retardant substrate, wherein the fabric is cotton or poly(ethylene terephthalate)-based (PET) fabric, but not limited thereto.

In one embodiment of the present invention, the flame-retardant substrate is produced by mixing, coating and drying from the liquid composition mentioned below, wherein the liquid composition comprises a waterborne Polyurethane molecule, a crosslinking molecule after hydrophilic modification, an aluminum hydroxide particle after surface modification and water. The waterborne Polyurethane molecule is the polyurethane dispersed in water, as a dispersion medium, instead of the organic solvent, the waterborne Polyurethane molecule has several hydrophilic groups, wherein the hydrophilic group can be selected from a sulfonyl group (—SO₃H) or a carboxyl group (—COOH), and the waterborne Polyurethane molecule has been previously synthesized for use.

Furthermore, the crosslinking molecule after hydrophilic modification is for example the isocyanate compound having a number of isocyanate groups (—NCO), for instance the oligomer of hexamethylene diisocyanate after hydrophilic modification, wherein the crosslinking molecule would bind to the waterborne Polyurethane by the isocyanate group after reacting with the waterborne Polyurethane molecule. In this embodiment, the crosslinking molecule has the formula as below:

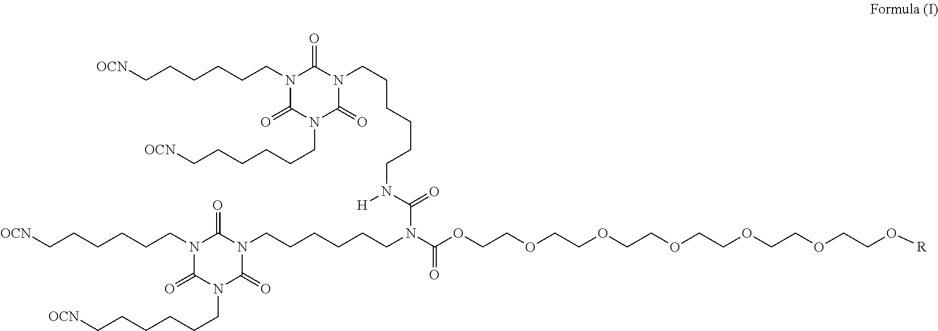

wherein R is selected from H or C₁-C₁₂ linear or branched chain alkyl or alkenyl group.

The crosslinking molecule after hydrophilic modification has isocyanate groups, when it mixes with water to form a reaction solution, the main chain of a plurality of the crosslinking molecules assemble to form the emulsion droplets due to the lipophilic property, but the crosslinking molecules on the surface of the emulsion droplets form a hydrophilic film thereon due to the reaction occurred between the isocyanate groups and water to produce the polyurea. Therefore, the crosslinking molecules are uniformly dispersed in water temporarily in form of emulsion droplets having the hydrophilic film, thereby protecting the internal unreacted isocyanate groups and slowing the consumption rate.

Further, the aluminum hydroxide particles after surface modification of this embodiment have predetermined average particle diameter between 1 and 15 microns. Each of the aluminum hydroxide particles has a plurality of amino groups (—NH₂) after surface modification, the amino groups are only located on the surface of the particles, in which the particles bind to at least one of the isocyanate groups of the isocyanate compounds via the amino group. When the flame-retardant coating material is heated in burning place, the particles of the aluminum hydroxide would be heated to release the vapor and turn into metal oxides to block heat conduction.

How to use the above formula to prepare flame-retardant coating material will be described hereinafter with several embodiments of the present invention, and whether the flame retardant properties are improved is discussed.

### EXAMPLE 1

First, preparing a solution containing the waterborne Polyurethane molecules for use, when perform the following reaction, the solution contains the waterborne Polyurethane molecules is further diluted by adding deionized water, then adding the aluminum hydroxide particles with surface modification (particle diameter are 1 and 8 μm), and stirring until evenly dispersed to form a diluted mixture.

Subsequently, preparing a solution having the crosslinking molecules with hydrophilic modification, so that the isocyanate groups of the crosslinking molecules (—NCO) on the surface react with water to form a first emulsion droplets and the hydrophilic film. Then, this emulsion droplets of the crosslinking molecules is added to the abovementioned diluted mixture and stirred until homogeneous, so that a liquid coating material is prepared, when the liquid coating material still contains water, the weight ratio of the composition is as shown in table 1:

TABLE 1
Weight ratio of the composition in the first embodiment

| | | | Aluminum | | | |
|---|---|---|---|---|---|---|
| | | Crosslinking | hydroxide | | | |
| | | molecules | particle | | | |
| | Waterborne | with | with surface | | Phosphorous | |
| | Polyurethane | hydrophilic | modification | | based flame | |
| example | molecules | modification | 8 um | 1 um | retardant | water |
| 1 | 50 g | 0.5 g | 20 g | 20 g | 10 g | 80 g |

In the liquid coating material as shown in Table 1, the weight ratio in solid of the waterborne Polyurethane molecule, the crosslinking molecules, the aluminum hydroxide particles and the phosphorus-based flame retardants (ammonium polyphosphate) is 50:0.5:40:10. In the aforestated table, there is about 45˜50 g of water from the weight of water in the solution of the waterborne Polyurethane molecules which is preliminarily prepared.

Finally, the liquid coating material is applied on a fabric by the way of wet coating, wherein the fabric can be selected from cotton or polyethylene terephthalate (PET) fabric. Then, the liquid coating material is dried at 160° C. until the water evaporates and turns into a flame-retardant coating layer. During the drying period, the droplet surface (polyurea layer) of the crosslinking molecules with hydrophilic modification is broken due to volume compression of the film, the unreacted isocyanate (—NCO) in internal was released and reacts with the waterborne Polyurethane molecule (R—NH—COOR′) at a high temperature to form crosslinking, while the aluminum hydroxide particles (ATH—NH₂) with the surface modification forming the organic/inorganic hybrid flame-retardant coating layer by the grafting reaction which have a thickness of about 0.3 mm. The flame-retardant coating layer may be coated on the single surface or both surfaces of the fabric to form a flame-retardant substrate.

Then, the flame-retardant substrate is disposed in an angle of 30 to 45 degrees on a flame to go a flame-retardant testing, and the test results show that the flame-retardant substrate indeed complies the CNS-7614 Anti-flame standards by measuring the carbonized area on the surface of the flame-retardant coating layer which is heating for two minutes, the detailed as in Table 2 below:

TABLE 2
The results of the samples in Example 1

| | Time of | | | | Time of | | |
|---|---|---|---|---|---|---|---|
| | Remaining | Embers | carbonized | | Remaining | Embers | |
| | Flame | time | length | | Flame | time | Carbonized |
| Sample | (secs.) | (secs.) | (cm) | Sample | (secs.) | (secs.) | length (cm) |
| No. | ≦5 | ≦60 | ≦10 | No. | ≦5 | ≦60 | ≦10 |
| longitude | 0 | 0 | 9 | latitude | 0 | 0 | 9 |
| | 0 | 0 | 9 | | 0 | 0 | 9 |
| | 0 | 0 | 9 | | 0 | 0 | 9 |

In which, the unit value of the longitude and latitude in the test results of time of remaining flame (seconds), embers time (seconds) and carbonized length (cm) must respectively be equal to or less than 5, 60 and 10. Through three test results of longitude and latitude are respectively 0, 0 and 9, it is therefore obvious within the rules of 5, 60 and 10, in other words, the test results show that the flame-retardant substrate indeed comply with the CNS-7614 Anti-flame standard when heating two minutes.

### EXAMPLE 2

The preparing method of the flame-retardant coating material is similar to that described in Example 1, first, preparing a solution containing the waterborne Polyurethane molecules for use, when perform the following reaction, the solution contains the waterborne Polyurethane molecules is further diluted by adding deionized water, then adding the aluminum hydroxide particles with surface modification (particle diameter is 8 μm) and the phosphorous-based flame retardants, and stirring until evenly dispersed to form a diluted mixture.

Then, preparing a solution having the crosslinking molecules with hydrophilic modification, so that the isocyanate groups of the crosslinking molecules (—NCO) on the surface react with water to form a first emulsion droplets, this emulsion droplets of the crosslinking molecules is added to the abovementioned diluted mixture and stirred until homogeneous, so that a liquid coating material is prepared, while the liquid coating material still contains water, the weight ratio of the composition is as shown in table 3:

TABLE 3
The weight ratio of composition of Example 2

| | | Crosslinking | Aluminum hydroxide | | | | |
|---|---|---|---|---|---|---|---|
| | Waterborne | molecules | particle with surface | | | Phosphorous | |
| | Polyurethane | with hydrophilic | modification | | | based flame | |
| example | molecules | modification | 55 um | 8 um | 1 um | retardant | water |
| 2 | 50 g | 0.5 g | 0 | 25 g | 0 | 30 g | 80 |

In the liquid coating material as shown in Table 3, the weight ratio in solid of the waterborne Polyurethane molecule, the crosslinking molecules, the aluminum hydroxide particles and the phosphorus-based flame retardants (ammonium polyphosphate) is 50:0.5:25:30. In the aforestated table, there is about 45˜50 g of water from the weight of water in the solution of the waterborne Polyurethane molecules which is preliminarily prepared.

Finally, the liquid coating material is applied on a fabric by the way of wet coating, and then the liquid coating material is dried at 160° C. until the water evaporates to turn into a flame-retardant coating layer with a thickness about 0.5 mm. The flame-retardant coating layer may be coated on the single surface or both surfaces of the fabric to form a flame-retardant substrate.

Subsequently, the flame-retardant substrate is disposed in an angle of 30 to 45 degrees on the flame to go a flame-retardant testing, and the test results show that the flame-retardant substrate indeed complies the CNS-10285A1 Anti-flame standards by measuring the carbonized area on the surface of the flame-retardant coating layer, the detailed as Table 4 below:

TABLE 4
The results of the samples in Example 2

| | | Time of | Embers | | carbonized |
|---|---|---|---|---|---|
| Heat | | Remaining | time | carbonized | length |
| time | | Flame (secs.) | (secs.) | area (cm²) | (cm) |
| (Minutes) | Direction | ≦3 | ≦5 | ≦30 | ≦20 |
| 1 min | Front in | 1 | 1 | 19 | 6 |
| | longitude | | | | |
| | Backside in | 1 | 1 | 18 | 6 |
| | longitude | | | | |
| | Front in | 1 | 1 | 20 | 7 |
| | latitude | | | | |
| 3 secs | Front in | 0 | 0 | 2 | N.A. |
| after | longitude | | | | |
| burning | Backside in | 0 | 0 | 1 | N.A. |
| | latitude | | | | |

It is known from above table that, after the reaction by heating or burning, and with the test of longitude and latitude, time of remaining flame (seconds), embers time (seconds), carbonized area (cm²) and carbonized length (cm) must respectively be equal to or less than 3, 5 and 20., in other words, the test result shows that the flame-retardant substrate indeed comply with the CNS-10285A1 Anti-flame standards.

### EXAMPLE 3

### Control Group

The preparing method of the flame-retardant coating material is similar to that described in Example 1, first, preparing a solution containing the waterborne Polyurethane molecules for use, when perform the following reaction, the solution contains the waterborne Polyurethane molecules is further diluted by adding deionized water, but the aluminum hydroxide particles with surface modification or the phosphorous-based flame retardants are not added.

Then, preparing a solution having the crosslinking molecules with hydrophilic modification, then adding to the abovementioned diluted mixture and stirred until homogeneous, so that a liquid coating material is prepared, while the liquid coating material still contains water, wherein the weight ratio of the composition is as shown in Table 5:

TABLE 5
The weight ratio of the composition of Example 3 (control group)

| | | | Aluminum | | | |
|---|---|---|---|---|---|---|
| | | Crosslinking | hydroxide | | | |
| | | molecules | particle | | | |
| | Waterborne | with | with surface | | Phosphorous | |
| | Polyurethane | hydrophilic | modification | | based flame | |
| example | molecules | modification | 8 um | 1 um | retardant | water |
| 3 | 50 g | 0.5 g | 0 | 0 | 0 | 80 g |

In the liquid coating material as shown in Table 5, the weight ratio in solid of the waterborne Polyurethane molecule and the crosslinking molecules is 50:0.5. In the aforestated table, there is about 45˜50 g of water from the weight of water in the solution of the waterborne Polyurethane molecules which is preliminarily prepared.

Finally, the liquid coating material is applied on a fabric by the way of wet coating, and then the liquid coating material is dried at 160° C. until the water evaporates to turn into a flame-retardant coating layer with a thickness about 30 microns. The flame-retardant coating layer may be coated on the single surface or both surfaces of the fabric to form a flame-retardant substrate.

Subsequently, the flame-retardant substrate of this example (control group) is disposed in an angle of 30 to 45 degrees on a flame to go a flame-retardant testing, and the test results show that the flame-retardant substrate is totally burned out so it cannot comply with CNS-7614 standards.

### EXAMPLE 4

The preparing method of the flame-retardant coating material is similar to that described in Example 1, first, preparing a solution containing the waterborne Polyurethane molecules for use, when perform the following reaction, the solution contains the waterborne Polyurethane molecules is further diluted by adding deionized water, then adding the aluminum hydroxide particles with surface modification (particle diameter is 8 μm) and the phosphorous-based flame retardants, and stirring until evenly dispersed to form a diluted mixture.

Then, preparing a solution having the crosslinking molecules with hydrophilic modification, so that the isocyanate groups of the crosslinking molecules (—NCO) on the surface react with water to form a first emulsion droplets, this emulsion droplets of the crosslinking molecules is added to the abovementioned diluted mixture and stirred until homogeneous, so that a liquid coating material is prepared, while the liquid coating material still contains water, the weight ratio of the composition is as shown in table 6:

TABLE 6
The weight ratio of composition of Example 4

| | | Crosslinking | | | | | |
|---|---|---|---|---|---|---|---|
| | | molecules | Aluminum hydroxide | | | | |
| | Waterborne | with | particle with surface | | | Phosphorous | |
| | Polyurethane | hydrophilic | modification | | | based flame | |
| example | molecules | modification | 55 um | 8 um | 1 um | retardant | water |
| 4 | 50 g | 1 g | 0 | 30 g | 30 g | 15 g | 125 g |

In the liquid coating material as shown in Table 6, the weight ratio in solid of the waterborne Polyurethane molecule, the crosslinking molecules, the aluminum hydroxide particles and the phosphorus-based flame retardants (ammonium polyphosphate) is 50:1:60:15. In the aforestated table, there is about 20˜30 g of water from the weight of water in the solution of the waterborne Polyurethane molecules which is preliminarily prepared.

Finally, the liquid coating material is applied on a paper by the way of wet coating, and then the liquid coating material is dried at 160° C. until the water evaporates to turn into a flame-retardant coating layer with an average thickness about 0.54 mm. The flame-retardant coating layer may be coated on the single surface or both surfaces of the paper to form a flame-retardant substrate.

Subsequently, the flame-retardant substrate is disposed in an angle of 30 to 45 degrees on the flame to go a flame-retardant testing, and the test results show that the flame-retardant substrate indeed complies level 3 of the CNS-7614 Anti-flame standards by measuring the carbonized length on the surface of the flame-retardant coating layer, the detailed as Table 7 below:

TABLE 7
The results of the samples in Example 4

| Heat time | | |
|---|---|---|
| (Minutes) | carbonized area (cm²) | carbonized length (cm) |
| 1 minutes | 33.77 cm² | 12.5 cm |

In which, the unit value in the test results of carbonized length (cm) must be equal to or less than 15. It is therefore obvious within the rule, in other words, the test results show that the flame-retardant substrates indeed comply with the CNS-7614 Anti-flame standard when heating one minute.

### EXAMPLE 5

The preparing method of the flame-retardant coating material is similar to that described in Example 1, first, preparing a solution containing the waterborne Polyurethane molecules for use, when perform the following reaction, the solution contains the waterborne Polyurethane molecules is further diluted by adding deionized water, then adding the aluminum hydroxide particles with surface modification (particle diameter is 8 μm) and the phosphorous-based flame retardants, and stirring until evenly dispersed to form a diluted mixture.

Then, preparing a solution having the crosslinking molecules with hydrophilic modification, so that the isocyanate groups of the crosslinking molecules (—NCO) on the surface react with water to form a first emulsion droplets, this emulsion droplets of the crosslinking molecules is added to the abovementioned diluted mixture and stirred until homogeneous, so that a liquid coating material is prepared, while the liquid coating material still contains water, the weight ratio of the composition is as shown in table 8:

TABLE 8
The weight ratio of composition of Example 5

| | | Crosslinking | | | | | |
|---|---|---|---|---|---|---|---|
| | | molecules | Aluminum hydroxide | | | | |
| | Waterborne | with | particle with surface | | | Phosphorous | |
| | Polyurethane | hydrophilic | modification | | | based flame | |
| example | molecules | modification | 55 um | 8 um | 1 um | retardant | water |
| 5 | 50 g | 1 g | 0 | 30 g | 30 g | 15 g | 125 g |

In the liquid coating material as shown in Table 8, the weight ratio in solid of the waterborne Polyurethane molecule, the crosslinking molecules, the aluminum hydroxide particles and the phosphorus-based flame retardants (ammonium polyphosphate) is 50:1:60:15. In the aforestated table, there is about 20˜30 g of water from the weight of water in the solution of the waterborne Polyurethane molecules which is preliminarily prepared.

Finally, the liquid coating material is applied on a polypropylene sheet by the way of wet coating, and then the liquid coating material is dried at 160° C. until the water evaporates to turn into a flame-retardant coating layer with an average thickness about 0.54 mm. The flame-retardant coating layer may be coated on the single surface or both surfaces of the polypropylene sheet to form a flame-retardant substrate.

Subsequently, the flame-retardant substrate is disposed in an angle of 30 to 45 degrees on the flame to go a flame-retardant testing, and the test results show that the flame-retardant substrate indeed complies level 2 of the CNS-7614 Anti-flame standards by measuring the carbonized length on the surface of the flame-retardant coating layer, the detailed as Table 9 below:

TABLE 9
The results of the samples in Example 5

| Heat time | | |
|---|---|---|
| (Minutes) | carbonized area (cm²) | carbonized length (cm) |
| 30 seconds | 34.02 cm² | 7.5 cm |

In which, the unit value in the test results of carbonized length (cm) must be equal to or less than 10. It is therefore obvious within the rule, in other words, the test results show that the flame-retardant substrates indeed comply with the CNS-7614 Anti-flame standard when heating 30 seconds.

As described above, comparing to Example 3 which shows that the flame-resistant substrate is burned out and cannot comply the flame-retardant standards, Examples 1, 2, 4 and 5 according to the present invention made of a waterborne Polyurethane resin, an isocyanate compound having a number of isocyanate groups and a metal hydroxide to form a non-halogen flame-retardant coating material, which can be coated on the substrate and dried to form the flame-retardant coating layer, which can indeed provide both non-toxic and flame-retardant properties which comply with environmental regulations; in Example 1, the relatively small amount of phosphorus-based flame retardant (ammonium polyphosphate)may be further added to, so that the flame retardant not only has advantages of Example 2, but also provides additional function of phosphorus flame retardant, and reducing shortcomings of the poor weather resistance and hygroscopicity caused by phosphorus-based flame retardant.

The flame-retardant coating material of the present invention may also have the addition of at least one metal powder or metal mesh, thus heat dissipation is improved, to avoid gathering the heat on a single point of the flame-retardant substrate; furthermore, to avoid concentrating the heat and burning through the flame retardant substrate.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A flame-retardant coating material, comprising:
(a) a polyurethane resin;
(b) an isocyanate compound having a plurality of isocyanate (—NCO) groups; and
(c) at least one metal hydroxide,
wherein the isocyanate groups of the isocyanate compound are linked respectively to the polyurethane resin and the metal hydroxide.

2. The flame-retardant coating material according to claim 1, wherein the weight ratio of the polyurethane resin, the isocyanate compound and the metal hydroxide is 50:0.1˜1:20˜80.

3. The flame-retardant coating material according to claim 1, further comprising a phosphorus-based flame retardant.

4. The flame-retardant coating material according to claim 1, further comprising expandable graphite.

5. The flame-retardant coating material according to claim 1, wherein the polyurethane resin has a plurality of hydrophilic groups selected from sulfonyl groups or carboxyl groups.

6. The flame-retardant coating material according to claim 1, wherein the isocyanate compound is an oligomer of hexamethylene diisocyanate modified by hydrophilic groups.

7. The flame-retardant coating material according to claim 1, wherein the metal hydroxide is magnesium hydroxide or aluminum hydroxide.

8. The flame-retardant coating material according to claim 1, wherein the average particle diameter of the metal hydroxide is between 1 and 15 um.

9. The flame-retardant coating material according to claim 8, wherein the metal hydroxide is modified by surface modification and has several amino groups.

10. The flame-retardant coating material according to claim 1, which further comprises a metal powder or a metal mesh.

11. A flame-resistant substrate, comprising:
a sheet material; and
a flame-retardant coating material according to claim 1, which is applied on the sheet material.

12. The flame-retardant substrate according to claim 11, wherein the sheet material is selected from a fabric, a paper or a plastic sheet.

13. The flame-retardant substrate according to claim 12, wherein the fabric is a cotton-based fabric or a poly(ethylene terephthalate)-based fabric.

14. The flame-retardant substrate according to claim 12, wherein the plastic sheet is a polypropylene sheet.
